(19) United States
(12) Patent Application Publication
(10) Pub. No.: US 2026/0171556 A1
(43) Pub. Date: Jun. 18, 2026

(54) PRESSURIZATION MECHANISM AND TESTING APPARATUS FOR ALL-SOLID-STATE BATTERY

(71) Applicants: NHK SPRING CO., LTD., Yokohama-shi (JP); TOYOTA JIDOSHA KABUSHIKI KAISHA, Toyota-shi (JP)

(72) Inventors: Takeshi UCHIDA, Yokohama-shi (JP); Masashi NAKAGOME, Yokohama-shi (JP); Jutaro OGAMI, Yokohama-shi (JP); Masashi KODAMA, Toyota-shi (JP)

(21) Appl. No.: 19/538,483

(22) Filed: Feb. 12, 2026

Related U.S. Application Data
(63) Continuation of application No. PCT/JP2024/026286, filed on Jul. 23, 2024.

(30) Foreign Application Priority Data
Aug. 22, 2023 (JP) 2023-134566

(51) Int. Cl. H01M 50/103; H01M 10/04; H01M 10/052; H01M 10/0525; H01M 50/55

(52) U.S. Cl. CPC H01M 50/103; H01M 10/0404; H01M 10/052; H01M 10/0525; H01M 50/55

(57) ABSTRACT

A pressurization mechanism for an all-solid-state battery including an all-solid-state battery cell arranged inside a fluid chamber filled with fluid, and a pressurization part having the fluid chamber and applying a predetermined pressure to the all-solid-state battery cell via the fluid. The fluid may be oil. The predetermined pressure may be generated by applying pressure to the fluid chamber. The pressurization part may include an upper shell member, a lower shell member, and a metal bellows arranged in a space defined by the upper shell member and the lower shell member.

### CROSS-REFERENCE TO RELATED APPLICATIONS

This application is a Continuation of International Patent Application No. PCT/JP2024/026286, filed on Jul. 23, 2024, which claims the benefit of priority to Japanese Patent Application No. 2023-134566, filed on Aug. 22, 2023, the entire contents of which are incorporated herein by reference.

### FIELD

The present invention relates to a pressurization mechanism for an all-solid-state battery.

### BACKGROUND

Conventionally, in addition to a battery using a liquid electrolyte, an all-solid-state battery using a solid electrolyte has been known. The all-solid-state battery is composed of a stacked body in which a positive electrode, a solid electrolyte, and a negative electrode are stacked in this order, and therefore, it is necessary to bring interfaces of the stacked body into good contact with each other. For example, Japanese Unexamined Patent Publication No. 2010-205479 discloses an all-solid-state battery in which pressure is applied to a stacked body in the stacking direction within a battery case containing the stacked body based on a detected voltage in order to stabilize a voltage during discharge of the all-solid-state battery.

### SUMMARY

A pressurization mechanism for an all-solid-state battery according to an embodiment of the present invention comprises an all-solid-state battery cell arranged inside a fluid chamber filled with fluid, and a pressurization part having the fluid chamber and applying a predetermined pressure to the all-solid-state battery cell via the fluid.

According to this configurationsince a predetermined pressure is applied to the all-solid-state battery cell via the fluid that surrounds the entire all-solid-state battery cell, the entire all-solid-state battery can be pressurized uniformly.

In a pressurization mechanism of the all-solid-state battery according to an embodiment of the present invention, the fluid can be configured to be oil.

A pressurization mechanism of the all-solid-state battery according to an embodiment of the present invention can be configured to generate the predetermined pressure by applying pressure to the fluid chamber.

In a pressurization mechanism of the all-solid-state battery according to an embodiment of the present invention, the pressurization part can be configured to include an upper shell member, a lower shell member, and metal bellows arranged in a space defined by the upper shell member and the lower shell member.

In a pressurization mechanism of the all-solid-state battery according to an embodiment of the present invention, the fluid chamber can be configured to be defined by the lower shell member and interior of the metal bellows.

In a pressurization mechanism of the all-solid-state battery according to an embodiment of the present invention, the fluid chamber can be configured to be defined by the lower shell member, an exterior of the metal bellows, and the upper shell member.

In a pressurization mechanism of the all-solid-state battery according to an embodiment of the present invention, the pressurization part can be configured to further include a bracket fixed to an upper surface of the lower shell member, and the all-solid-state battery can be configured to be fixed to the bracket at a position spaced apart from the lower shell member.

The pressurization mechanism of the all-solid-state battery according to an embodiment of the present invention further comprises an electrode electrically connected to the all-solid-state battery cell, wherein the electrode can be configured to pass through the lower shell member and be exposed to the outside.

A testing apparatus for an all-solid-state battery according to an embodiment of the present invention comprises a pressurization part having a first fluid chamber filled with a first fluid and applying a predetermined pressure to an all-solid-state battery cell via the first fluid.

According to this configuration, since a predetermined pressure is applied to the all-solid-state battery cell via the first fluid that surrounds the entire all-solid-state battery cell, the entire all-solid-state battery can be pressurized uniformly.

In a testing apparatus for an all-solid-state battery according to an embodiment of the present invention, the pressurization part can be configured to have a second fluid chamber filled with a second fluid, and a free piston arranged between the first fluid chamber and the second fluid chamber.

In a testing apparatus for an all-solid-state battery according to an embodiment of the present invention, the first fluid and the second fluid are configured to be different fluids.

In a testing apparatus for an all-solid-state battery according to an embodiment of the present invention, the pressurization part can be configured to further include a pressurization device connected to the second fluid chamber.

In a testing apparatus for an all-solid-state battery according to an embodiment of the present invention, the pressurization part can be configured to further include a bracket fixed to an opposing surface facing the free piston of a wall of the first fluid chamber, and the bracket can be configured to fix the all-solid-state battery cell at a space apart from the opposing surface.

A testing apparatus for an all-solid-state battery according to an embodiment of the present invention includes an electrode electrically connected to the all-solid-state battery cell, and the electrode is configured to pass through the opposing surface and is exposed to the outside.

In a testing apparatus for an all-solid-state battery according to an embodiment of the present invention, the pressurization part is configured to further include a pressure adjustment part capable of adjusting an internal pressure of the second fluid chamber.

In a pressurization mechanism and a testing apparatus for an all-solid-state battery according to an embodiment of the present invention, the entire all-solid-state battery can be pressurized uniformly.

### BRIEF DESCRIPTION OF DRAWINGS

FIG. 1 is a cross-sectional view schematically showing a pressurization mechanism 1 of an all-solid-state battery according to a first embodiment of the present invention.

FIG. 2 is an enlarged cross-sectional view schematically showing an all-solid-state battery cell 11 attached to the pressurization mechanism 1.

FIG. 3A is a plan view schematically showing the all-solid-state battery cell 11.

FIG. 3B is a cross-sectional view schematically showing the all-solid-state battery cell 11.

FIG. 4 is a cross-sectional view schematically showing the pressurization mechanism 1 of an all-solid-state battery according to a second embodiment of the present invention.

FIG. 5 is an enlarged cross-sectional view schematically showing the all-solid-state battery cell 11 attached to the pressurization mechanism 1.

FIG. 6A is a cross-sectional side view schematically showing a testing apparatus 2 according to an embodiment of the present disclosure.

FIG. 6B is a cross-sectional plan view schematically showing the testing apparatus 2 according to an embodiment of the present disclosure.

FIG. 7 is an enlarged cross-sectional view schematically showing the all-solid-state battery cell 11 attached to the testing apparatus 2.

### DESCRIPTION OF EMBODIMENTS

In an all-solid-state battery disclosed in Japanese Unexamined Patent Publication No. 2010-205479, there is a possibility that a stacked body is uniaxially pressurized to cause deformation and is locally pressurized in a plane of the stacked body. Local pressurization can cause cracking and wrinkling of the stacked body.

An object of the present invention is to provide a pressurization mechanism and a testing apparatus for an all-solid-state battery capable of uniformly pressurizing the entire all-solid-state battery.

### [Pressurization Mechanism]

First, a pressurization mechanism of an all-solid-state battery according to an embodiment of the present invention will be described with reference to the drawings.

### First Embodiment of Pressurization Mechanism

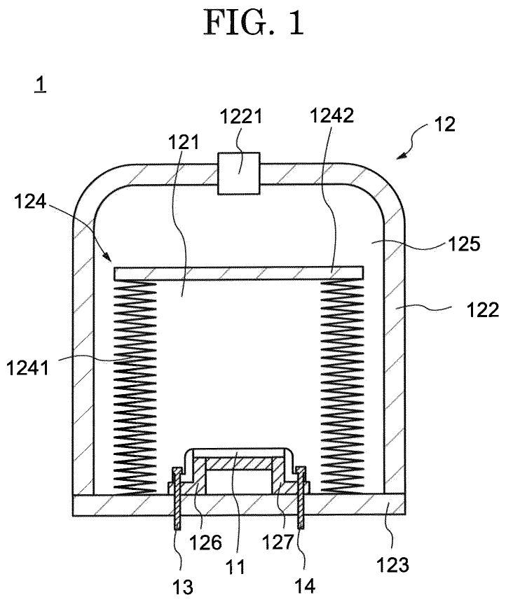

FIG. 1 is a cross-sectional view schematically showing a pressurization mechanism 1 of an all-solid-state battery according to an embodiment of the present invention. As shown in FIG. 1, the pressurization mechanism 1 of an all-solid-state battery comprises an all-solid-state battery cell 11 arranged inside a fluid chamber 121 filled with a fluid, and a pressurization part 12 having the fluid chamber 121 and applying a predetermined pressure to the all-solid-state battery cell 11 via the fluid.

As shown in FIG. 1, the pressurization part 12 includes an upper shell member 122 made of a cylindrical metal having an open lower end, and a lower shell member 123 made of a disk-shaped metal sealing the opening of the upper shell member 122. A check valve 1221 for filling a fluid is arranged on an upper surface of the upper shell member 122. The upper shell member 122 and the lower shell member 123 are welded and sealed. Further, a plurality of screw holes may be formed in the upper shell member 122, a plurality of through holes may be formed in the lower shell member 123, and a groove into which an O-ring is fitted may be formed in each of the upper shell member 122 and the lower shell member 123. In this case, the upper shell member 122 and the lower shell member 123 can be sealed by inserting an O-ring and fastening the upper shell member 122 and the lower shell member 123 together with screws.

The pressurization part 12 includes metal bellows 124 arranged in a space defined by the upper shell member 122 and the lower shell member 123. The metal bellows 124 has a cylindrical bellows body 1241 open at both ends and a bellows cap 1242 welded to one end of the bellows body 1241 to seal the opening of the bellows body 1241. Since the bellows body 1241 is formed in a bellows shape in which peaks and valleys are alternately formed in an axial direction of the cylinder, the metal bellows 124 can expand and contract.

The fluid chamber 121 is configured as an internal space of a structure made up of the lower shell member 123 and the metal bellows 124. The lower shell member 123 and the metal bellows 124 are welded together and the opening at the other end of the metal bellows 124 is sealed. The fluid to be filled in the fluid chamber 121 may be, for example, a gas such as air or nitrogen gas, or a liquid such as water or oil, and an oil that is an incompressible fluid and has good responsiveness is preferable.

In addition, another fluid chamber 125 is configured as an outer space not occupied by the metal bellows 124 in the internal space of the structure including the upper shell member 122 and the lower shell member 123. The fluid filled in the fluid chamber 125 may be, for example, a gas such as air or nitrogen gas, or a liquid such as water or oil, similar to the fluid chamber 121. In the case where the fluid chamber 121 is filled with oil, nitrogen gas is preferable from the viewpoint of efficiently and uniformly pressurizing the all-solid-state battery cell 11.

The pressurization part 12 includes brackets 126 and 127 fixed to an upper surface of the lower shell member 123, and the all-solid-state battery cell 11 is fixed to the brackets 126 and 127 at positions spaced apart from the lower shell member 123.

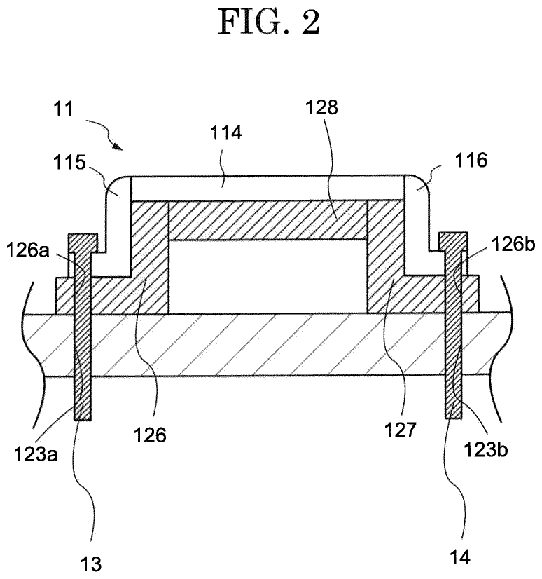

FIG. 2 is an enlarged cross-sectional view schematically showing the all-solid-state battery cell 11 attached to the pressurization mechanism 1. The lower shell member 123 is formed with through holes 123a and 123b into which screw-shaped electrodes 13 and 14 are inserted, corresponding to through holes 115a and 116a of lead terminals 115 and 116 of the all-solid-state battery cell 11 described later.

The brackets 126 and 127 are made of metal and are formed in an L-shape in a cross-sectional view as shown in FIG. 2. A metal plate 128 that supports the all-solid-state battery cell 11 is coupled to upper ends of the brackets 126 and 127. Further, the end portions of the brackets 126 and 127 are formed with through holes 126a and 126b into which the electrodes 13 and 14 are inserted, corresponding to the through holes 115a and 116a of the lead terminals 115 and 116. The screw-shaped electrodes 13 and 14 are inserted into the respective through holes in the order of the all-solid-state battery cell 11, the brackets 126 and 127, and the lower shell member 123, and the all solid state battery cell 11 can be fixed to the pressurization part 12 by being tightened by a nut (not shown) from below. Further, since the lead terminals 115 and 116 have a shape along the L-shaped cross section of the brackets 126 and 127, the all-solid-state battery cell 11 is fixed at positions spaced apart from the lower shell member 123. From the viewpoint of the sealing property of the fluid chamber 121 and the insulating property between the all-solid-state battery cell 11 and the lower shell member 123, for example, a flat washer, a seal washer, and insulating tape can be interposed between the electrodes 13 and 14 and the lead terminals 115 and 116, between the lead terminals 115 and 116 and the brackets 126 and 127, and between the brackets 126 and 127 and the lower shell member 123.

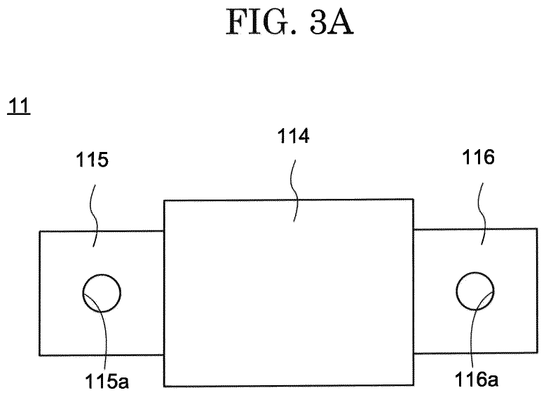

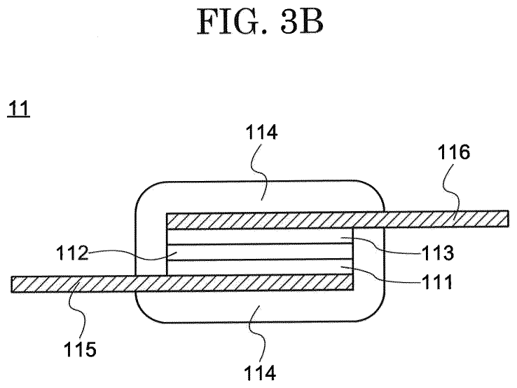

FIG. 3A is a plan view schematically showing the all-solid-state battery cell 11. FIG. 3B is a cross-sectional view schematically showing the all-solid-state battery cell 11. As shown in FIG. 3B, the all-solid-state battery cell 11 has a stacked body in which a positive electrode 111, a solid electrolyte 112, and a negative electrode 113 are stacked in this order, and a packaging material 114 that stores the stacked body and is made of a synthetic resin film. The all-solid-state battery cell 11 further has lead terminals 115 and 116 each of which is connected to one surface of the positive electrode 111 and one surface of the negative electrode 113 in the packaging material 114 and is made of a metal foil. The lead terminals 115 and 116 are led out of the packaging material 114 from one end and the other end of the packaging material 114, respectively, while maintaining the sealed state of the packaging material. As shown in FIG. 3A, the end portions of the respective lead terminals 115 and 116 are formed with through holes 115a and 116a into which the screw-shaped electrodes 13 and 14 are inserted.

[Method for Attaching all-Solid-State Battery Cell in Pressurization Mechanism]

First, the all-solid-state battery cell 11 is prepared, and the screw-shaped electrodes 13 and 14 are inserted into the through holes of the all-solid-state battery cell 11, brackets 126 and 127, and lower shell member 123 in this order, and are temporarily fixed with nuts. Next, the metal bellows 124 and the lower shell member 123 are welded, and the upper shell member 122 and the lower shell member 123 are welded. Then, since the nuts are not finally fixed and a gap is formed in the through holes 123a and 123b of the lower shell member 123 into which the screw-shaped electrodes 13 and 14 are inserted, oil is filled from one of the through holes 123a and 123b, and the other through holes 123a and 123b are used as an air vent hole. When the fluid chamber 121 is sufficiently filled with oil, the nut of the lower shell member 123 is finally fixed to fix the all-solid-state battery cell 11 to the lower shell member 123. Finally, nitrogen gas is filled into the fluid chamber 125 to a predetermined pressure through the check valve 1221 of the upper shell member 122.

### [Operation of Pressurization Mechanism]

In the fluid chamber 121, a predetermined pressure is applied to the all-solid-state battery cell 11 via oil surrounding the entire all-solid-state battery cell 11, so that the all-solid-state battery cell 11 can be uniformly pressurized. In the case where a temperature change occurs in the all-solid-state battery cell 11, a volume of the fluid chamber 121 changes, and a predetermined pressure is applied to the metal bellows 124 through the nitrogen gas inside the fluid chamber 125, so that the metal bellows 124 expands and contracts under a pressure close to the predetermined pressure. That is, even in the case where a temperature change occurs in the all-solid-state battery cell 11, the entire all-solid-state battery cell 11 can be uniformly pressurized.

### Second Embodiment of Pressurization Mechanism

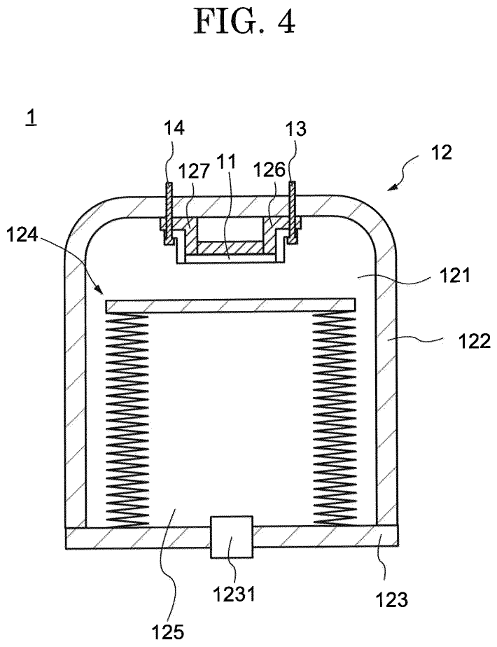

Although the pressurization mechanism of the all-solid-state battery according to the embodiment of the present invention has been described above, the specific aspect of the present invention is not limited to the above embodiment. For example, in the above embodiment, the fluid chamber 121 is configured by the lower shell member 123 and the inside of the metal bellows 124, and the fluid chamber 125 is configured by the upper shell member 122, the lower shell member 123, and the outside of the metal bellows 124. As shown in FIG. 4, the fluid chamber 121 may be configured by the lower shell member 123, the outside of the metal bellows 124, and the upper shell member 122, and the fluid chamber 125 may be configured by the inside of the metal bellows 124 and the lower shell member 123. In the second embodiment, the lower shell member 123 is provided with a check valve 1231 for filling the fluid.

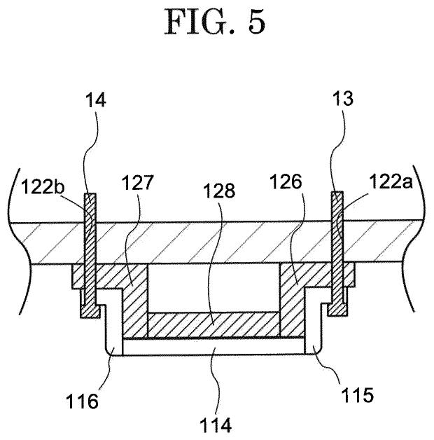

FIG. 5 is an enlarged cross-sectional view schematically showing the all-solid-state battery cell 11 attached to the pressurization mechanism 1 according to a modified example. As shown in FIG. 5, the upper shell member 122 has the through holes 122a and 122b into which the screw-shaped electrodes 13 and 14 are inserted, corresponding to the through holes 115a and 116a of the lead terminals 115 and 116 of the all-solid-state battery cell 11.

### [Method for Attaching All-Solid Battery Cells in Pressurization Mechanism]

First, the all-solid-state battery cell 11 is prepared, and the screw-shaped electrodes 13 and 14 are inserted into the through holes in the order of the all-solid-state battery cell 11, the brackets 126 and 127, and the upper shell member 122, and temporarily fixed with nuts. Next, the metal bellows 124 and the lower shell member 123 are welded, and the upper shell member 122 and the lower shell member 123 are welded. Then, since the nut is not finally fixed and a gap is formed in the through holes 122a and 122b of the upper shell member 122 into which the screw-shaped electrodes 13 and 14 are inserted, oil is filled from one of the through holes 122a and 122b, and the other through holes 122a and 122b are used as an air vent hole. When the fluid chamber 121 is sufficiently filled with oil, the nut of the upper shell member 122 is finally fixed to fix the all-solid-state battery cell 11 to the upper shell member 122. Finally, nitrogen gas is filled into the fluid chamber 125 to a predetermined pressure through the check valve 1231 of the lower shell member 123.

### [Operation of Pressurization Mechanism]

In the fluid chamber 121, a predetermined pressure is applied to the all-solid-state battery cell 11 via oil surrounding the entire all-solid-state battery cell 11, so that the all-solid-state battery cell 11 can be uniformly pressurized. In the case where a temperature change occurs in the all-solid-state battery cell 11, a volume of the fluid chamber 121 changes, and a predetermined pressure is applied to the metal bellows 124 through the nitrogen gas inside the fluid chamber 125, so that the metal bellows 124 expands and contracts under a pressure close to the predetermined pressure. That is, even in the case where a temperature change occurs in the all-solid-state battery cell 11, the entire all-solid-state battery cell 11 can be uniformly pressurized. In the second embodiment, the movement of the metal bellows 124 is opposite to the metal bellows 124 in the first embodiment.

### [Testing Apparatus]

Next, a testing apparatus for an all-solid-state battery according to an embodiment of the present invention will be described with reference to the drawings.

### [Configuration of Testing Apparatus]

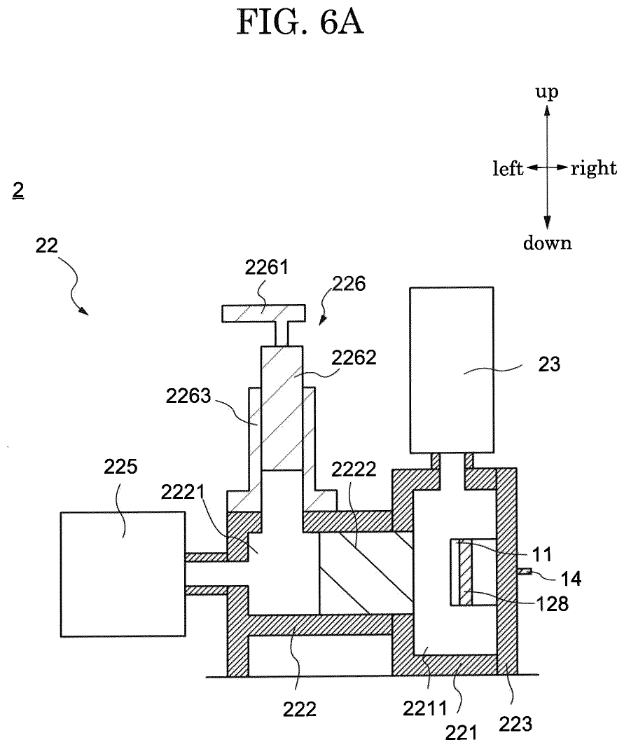

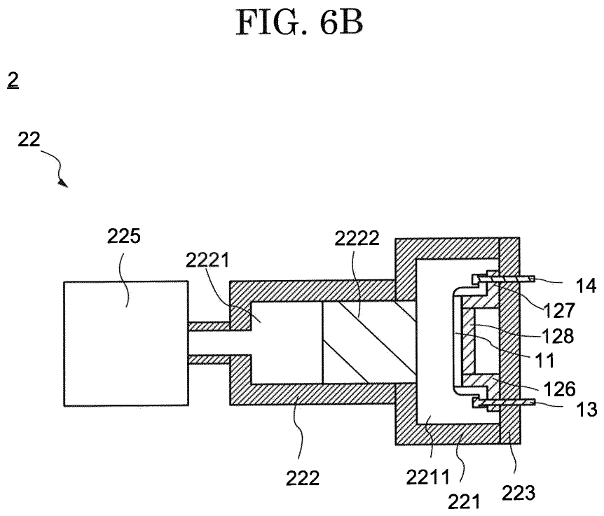

FIG. 6A is a cross-sectional side view schematically showing the testing apparatus 2 for an all-solid-state battery. Further, FIG. 6B is a cross-sectional plan view schematically showing the testing apparatus 2 of the all-solid-state battery. In FIG. 6A, although an up and down direction and a left and right direction are defined and the testing apparatus 2 is described with reference to the up and down direction and the left and right direction, the direction when the testing apparatus 2 is used is not limited thereto. As shown in FIG. 6A, the testing apparatus 2 for the all-solid-state battery comprises a pressurization part 22 and a pressure gauge 23. The pressurization part 22 has a first fluid chamber 2211 filled with the first fluid, a second fluid chamber 2221 filled with the second fluid, and a free piston 2222 arranged between the first fluid chamber 2211 and the second fluid chamber 2221, and applies a predetermined pressure to the all-solid-state battery cell 11 through the fluid.

As shown in FIG. 6A, the pressurization part 22 is composed of a first body 221 that is opened to the right and is made of a metal having a cavity inside, and a second body 222 that is connected to the first body 221 and linked with the cavity of the first body 221 and is made of a metal having a cavity inside. The first fluid chamber 2211 is formed of the first body 221 and a disk-shaped fixing part 223 fixed to the first body 221 by a bolt or the like.

Examples of the first fluid to be filled in the first fluid chamber 2211 include a gas such as air or nitrogen gas, and a liquid such as water or oil. From the viewpoint of uniformly pressurizing the all-solid-state battery cell 11 with insulating properties, flowable paraffin is preferable.

As shown in FIG. 6A, the free piston 2222 is arranged inside the second body 222 that moves along the cavity of the second body 222. Within the second body 222, a left space not occupied by the free piston 2222 forms the second fluid chamber 2221. As the free piston 2222 moves, the pressure inside the first fluid chamber 2211 and the pressure inside the second fluid chamber 2221 become the same.

Examples of the second fluid that fills the second fluid chamber 2221 include a gas such as air or nitrogen gas, and a liquid such as water or oil. In the case where the first fluid is a flowable paraffin, the second fluid is a fluid having little pressure fluctuation due to volume change or temperature change, and is preferably an oil.

The pressurization part 22 further includes the brackets 126 and 127 fixed to an opposing surface (that is, the fixing part 223) facing the free piston 2222 of a wall surface of the first fluid chamber 2211, and the all-solid-state battery cell 11 is fixed to the brackets 126 and 127 at positions spaced apart from the opposing surface.

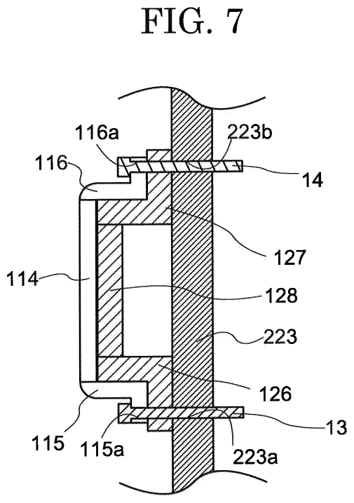

FIG. 7 is an enlarged cross-sectional view schematically showing the all-solid-state battery cell 11 attached to the testing apparatus 2. As shown in FIG. 7, the fixing part 223 has through holes 223a and 223b into which the screw-shaped electrodes 13 and 14 are inserted, corresponding to the through hole 115a, 116a of the lead terminals 115 and 116 of the all-solid-state battery cell 11.

The pressurization part 22 includes a pressurization device 225 that pressurizes the second fluid chamber 2221. As shown in FIG. 6A, the pressurization device 225 is linked with the second fluid chamber 2221 and is arranged on a left side of the second fluid chamber 2221. From the viewpoint of simply pressurizing the all-solid-state battery cell 11, a pressurization device including a metal bellows inside the metal shell body is preferable as the pressurization device 225. Since the metal bellows is linked with the second fluid chamber 2221 in the pressurization device, the inside of the metal bellows is filled with the same second fluid as the second fluid chamber 2221. Further, the metal shell body is provided with an inlet for filling nitrogen gas, and a space inside the metal shell body in which the metal bellows is not occupied is filled with nitrogen gas. By filling the nitrogen gas from the inlet of the metal shell body, the metal bellows is contracted, so that the second fluid chamber 2221 can be pressurized. The pressurization device 225 is not limited to this example, and a known pressurization device can be used.

The pressurization part 22 includes a pressure adjustment part 226 capable of adjusting an internal pressure of the second fluid chamber 2221. As shown in FIG. 6A, the pressure adjustment part 226 is linked with the second fluid chamber 2221 and is arranged above the second fluid chamber 2221. The pressure adjustment part 226 includes a pressure adjustment handle 2261 that can be gripped, a rod-shaped pressure adjustment rod 2262 that is connected to the pressure adjustment handle 2261 and is threaded on an outer peripheral surface, and an adjustment part body 2263 that is formed in a cylindrical shape and has a cavity inside in which a screw corresponding to the screw of the pressure adjustment rod 2262 is threaded on an inner peripheral surface and the pressure adjustment rod 2262 is inserted. The interior of the adjustment part body 2263 is linked with the second fluid chamber 2221, and a lower space within the adjustment part body 2263 that is not occupied by the pressure adjustment rod 2262 is filled with the second fluid. By gripping the pressure adjustment handle 2261 and rotating the pressure adjustment rod 2262, the position of the pressure adjustment rod 2262 moves up and down, and a ratio of the volume occupied by the pressure adjustment rod 2262 inside the adjustment part body 2263 changes, so that the internal pressure of the second fluid chamber 2221 changes. Further, in the case where a pressurization device including a metal bellows inside the metal shell body is used as the pressurization device 225, when the ratio of the volume occupied by the pressure adjustment rod 2262 inside the adjustment part body 2263 changes, the volume in the metal bellows changes, and accordingly, the volume of the space in the metal shell body in which the metal bellows is not occupied also changes, and an internal pressure of the second fluid chamber 2221 changes. As a result, the internal pressure of the first fluid chamber 2211 can be adjusted.

The testing apparatus 2 comprises a known pressure gauge 23 for measuring the pressure in the first fluid chamber 2211. As shown in FIG. 6A, the pressure gauge 23 is linked with the first fluid chamber 2211 and is arranged above the first body 221. The pressure gauge 23 can measure the pressure in the first fluid chamber 2211, that is, the pressure applied to the all-solid-state battery cell 11.

### [Method for Attaching All-Solid-State Battery Cell in Testing Apparatus]

First, the all-solid-state battery cell 11 is prepared, and the all-solid-state battery cell 11, the brackets 126 and 127, and the fixing part 223 are inserted into respective through holes with screw-shaped electrodes 13 and 14, and tightened with nuts to fix the all-solid-state battery cell 11 to the fixing part 223. Next, the free piston 2222 is inserted into the second body 222, the pressurization device 225 and the first body 221 are assembled to the second body 222, and the fixing part 223 is assembled to the first body 221. Further, the adjustment part body 2263 is attached to the second body 222. Then, in the first body 221, the first fluid is filled from the through hole to which the pressure gauge 23 is attached, and the pressure gauge 23 is attached to the first body 221. Further, the second fluid is filled from the cavity of the adjustment part body 2263, and the pressure adjustment rod 2262 to which the pressure adjustment handle 2261 is attached is inserted into the adjustment part body 2263.

### [Operation of Testing Apparatus]

In the case where the all-solid-state battery cell 11 is pressurized, the second fluid chamber 2221 is pressurized by the pressurization device 225 until a predetermined pressure is reached while checking the pressure gauge 23. The first fluid chamber 2211 is pressurized through the second fluid chamber 2221 and the free piston 2222. Since a predetermined pressure is applied to the all-solid-state battery cell 11 via the first fluid surrounding the entire all-solid-state battery cell 11, the all-solid-state battery cell 11 can be uniformly pressurized. Since the all-solid-state battery cell 11 is uniformly pressurized by the fluid, it can be said that the same pressurized state as that of the pressurization mechanism 1 described above can be reproduced. In this state, the performance of the all-solid-state battery cell 11 can be evaluated by measuring a voltage or the like from the electrodes 13 and 14.

In the case where it is desired to finely adjust the pressure applied to the all-solid-state battery cell 11, the pressure by the pressurization device 225 is kept constant, and the pressure adjustment rod 2262 is rotated using the pressure adjustment handle 2261 to adjust the position of the pressure adjustment rod 2262. As a result, the volume inside the adjustment part body 2263 changes, so that the pressure applied to the all-solid-state battery cell 11 is changed via the second fluid in the second fluid chamber 2221, the free piston 2222, and the first fluid. Further, in the case where a pressurization device including a metal bellows inside the metal shell body is used as the pressurization device 225, the volume in the metal bellows changes, and accordingly, the volume of the space in the metal shell body in which the metal bellows is not occupied also changes, and the internal pressure in the second fluid chamber 2221 changes, so that the pressure applied to the all-solid-state battery cell 11 changes via the free piston 2222 and the first fluid. In the case where a temperature change occurs in the all-solid-state battery cell 11, since the free piston 2222 is pressurized from the second fluid chamber 2221 at a predetermined pressure, the free piston 2222 moves while maintaining the predetermined pressure. That is, even in the case where a temperature change occurs in the all-solid-state battery cell 11, the entire all-solid-state battery cell 11 can be uniformly pressurized. The free piston 2222 will act as the metal bellows 124 in the pressurization mechanism 1.

What is claimed is:

1. A pressurization mechanism for an all-solid-state battery, comprising:
an all-solid-state battery cell arranged inside a fluid chamber filled with fluid; and
a pressurization part having the fluid chamber and applying a predetermined pressure to the all-solid-state battery cell via the fluid.

2. The pressurization mechanism for an all-solid-state battery according to claim 1, wherein
the fluid is oil.

3. The pressurization mechanism for an all-solid-state battery according to claim 1, wherein
the predetermined pressure is generated by applying pressure to the fluid chamber.

4. The pressurization mechanism for an all-solid-state battery according to claim 1, wherein
the pressurization part includes an upper shell member, a lower shell member, and a metal bellows arranged in a space defined by the upper shell member and the lower shell member.

5. The pressurization mechanism for an all-solid-state battery according to claim 4, wherein
the fluid chamber is defined by the lower shell member and an interior of the metal bellows.

6. The pressurization mechanism for an all-solid-state battery according to claim 4, wherein
the fluid chamber is defined by the lower shell member, an exterior of the metal bellows, and the upper shell member.

7. The pressurization mechanism for an all-solid-state battery according to claim 5, wherein
the pressurization part further includes a bracket fixed to an upper surface of the lower shell member, and
the all-solid-state battery is fixed to the bracket at a position spaced apart from the lower shell member.

8. The pressurization mechanism for an all-solid-state battery according to claim 1, further comprising:
an electrode electrically connected to the all-solid-state battery cell, wherein
the electrode passes through the lower shell member and is exposed to the outside.

9. A testing apparatus for an all-solid-state battery, comprising:
a pressurization part having a first fluid chamber filled with a first fluid and applying a predetermined pressure to an all-solid-state battery cell via the first fluid.

10. The testing apparatus for an all-solid-state battery according to claim 9, wherein
the pressurization part has a second fluid chamber filled with a second fluid, and a free piston arranged between the first fluid chamber and the second fluid chamber.

11. The testing apparatus for an all-solid-state battery according to claim 10, wherein
the first fluid and the second fluid are different fluids.

12. The testing apparatus for an all-solid-state battery according to claim 10, wherein
the pressurization part further includes a pressurization device connected to the second fluid chamber.

13. The testing apparatus for an all-solid-state battery according to claim 10, wherein
the pressurization part further includes a bracket fixed to an opposing surface facing the free piston of a wall of the first fluid chamber, and
the bracket fixes the all-solid-state battery cell at a position spaced apart from the opposing surface.

14. The testing apparatus for an all-solid-state battery according to claim 13, further comprising:
an electrode electrically connected to the all-solid-state battery cell, wherein
the electrode passes through the opposing surface and is exposed to the outside.

15. The testing apparatus for an all-solid-state battery according to claim 10, wherein
the pressurization part further includes a pressure adjustment part capable of adjusting an internal pressure of the second fluid chamber.
